(19) United States
(12) Patent Application Publication
(10) Pub. No.: US 2007/0130903 A1
(43) Pub. Date: Jun. 14, 2007

(54) Method and apparatus for grade and angle determining rake

(76) Inventor: Dale Nels Sunde, Sparks, NV (US)

Correspondence Address: LONG & CHYBIK, 1575 DELUCCHI LANE, SUITE 32, RENO, NV, 89502, US

(21) Appl. No.: 11/636,249

(22) Filed: Dec. 8, 2006

Related U.S. Application Data
(60) Provisional application No. 60/749,191, filed on Dec. 9, 2005.

(51) Int. Cl. A01D 7/00

(52) U.S. Cl. 56/400.01

(57) ABSTRACT

One possible embodiment of the invention could be a rake comprising of a body, the body further comprising of a blade to which is attaches to a handle, and a grade determination device, the grade determination device attaches to the body.

### CROSS-REFERENCES TO RELATED APPLICATIONS AND DOCUMENTS

This application relates to the Disclosure Document having the identification number 587748 and the filing date of Oct. 11, 2005.

This application relates to and claims the filing date of the Provisional Patent Application having the Ser. No. 60/749,191 filed Dec. 9, 2005.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention may generally relate to rakes and more in particular to those rakes that may be used in leveling and determining the grade of placed materials.

### BACKGROUND

When a landscape gardener is setting up a landscape, he or she may often have to move and properly place landscaping material (e.g., particulate or granular matter like gravel, decomposed granite, sand, dirt, and the like) at certain grade(s). These grades may be at certain angles of inclination to properly set the swale for the landscaped grounds (e.g., angle the grounds to ensure proper runoff and drainage of rainwater and the like).

One possible way of accomplishing this grading task is for the landscape gardener to use one or more sets of a line tied between two sticks. The two sticks may be anchored into the landscape material to be graded so that a line may be pulled taunt between them at an angle of inclination for a desired grade. The height of respective sticks (hence the angle of inclination of the string) may then be adjusted using a bubble level. The grade is then imparted to the material by a board being held at each end by a worker, the board being located between the two sets of line and sticks. The workers then may repeatedly move the edge of the board along the material while generally following as a guide for grading, the angles of inclination as set by the lines. The workers may then check the actual angle of inclination of the graded material by using a bubble level placed upon the top surface of the material. This methodology may not seem to be that efficient because it may require two workers for its operations as well as require repeated stopping of operations to check the actual angle of inclination of the graded material with a bubble level.

Another possible methodology could involve grading the material by board, rake or the like, then stopping the grading action while the actual angle of inclination for the grade may be checked by a bubble level. If the material is not graded at the desired angle, then some of the material may be re-graded and the angle of inclination may then be checked again. This process may continue until the material being worked achieves the desired grade. This methodology also may require a plurality of workers as well as impose a continual stoppage of grading operations to check the actual grade of the material.

What is needed therefore is a method and apparatus for a landscaping rake, which can be operated by an individual to simultaneously grade materials and check the angle of the inclination for the grade being imparted to the material.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to allow one individual to simultaneous grade and measure the grade of material being used in landscaping;

provide a landscape rake incorporating a means for checking the grade of the landscape material being worked upon by the rake.

the ability to change the grade of the placement of material being used in landscaping without having to use separate grade determination devices;

provide a landscape rake, which may incorporate a means for checking the angle of inclination of the blade of rake;

These and other advantages may be realized by reference to the remaining portions of the specification, claims, and abstract.

### BRIEF DESCRIPTION OF ONE EMBODIMENT OF THE PRESENT INVENTION

One possible embodiment could be a landscaping rake comprising a body, the body comprising of a blade to which is attached a handle, and a grade determination device, the grade determination device being attached to the body.

Another possible version of the embodiment could be a landscaping rake comprising a blade means, a handle means for transmitting force to the blade means, and a grade determination means for determining an angle of inclination of the blade means.

Another possible version of the embodiment could be a method of operating a landscaping rake comprising providing a rake to which is attached a grade determination device, placing the rake in contact with the material, and observing the grade determination device to determine the grade of the material.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology, terminology, labeling of paragraphs are employed herein are for the purpose of description and should not be regarded as limiting.

### BRIEF DESCRIPTION OF THE DRAWINGS

FIG. 1 is substantially a perspective view of an embodiment of the present invention.

FIG. 2 is substantially a perspective view of an embodiment of the present invention.

FIG. 3 is substantially a perspective view of an embodiment of the present invention.

FIG. 4 is substantially a perspective view of an embodiment of the present invention.

FIG. 5 is substantially a perspective view of an embodiment of the present invention.

FIG. 6 is substantially a perspective view of an embodiment of the present invention.

FIG. 7 is substantially a perspective view of an embodiment of the present invention

FIG. 8 is substantially a schematic presentation of embodiment of a method for operating the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

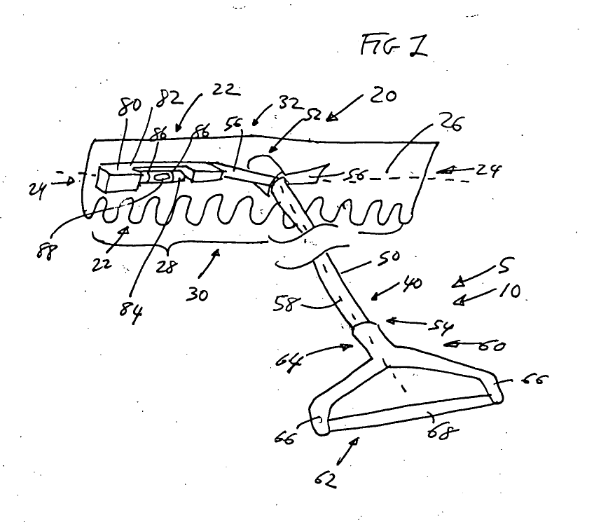

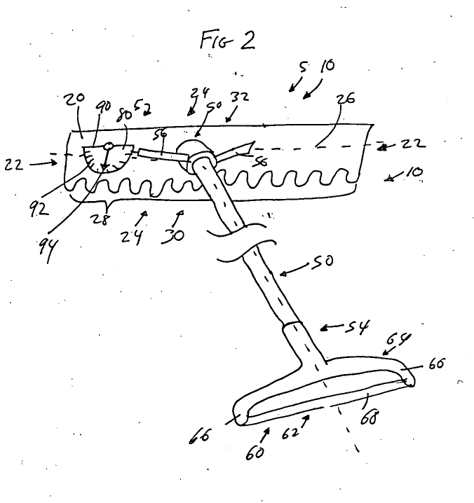

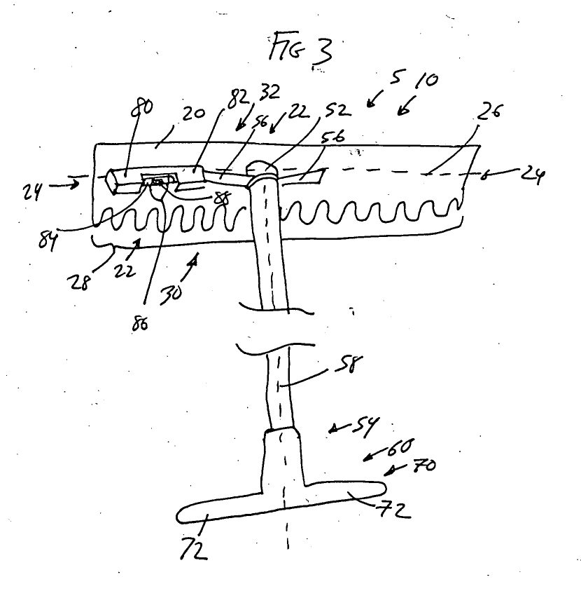

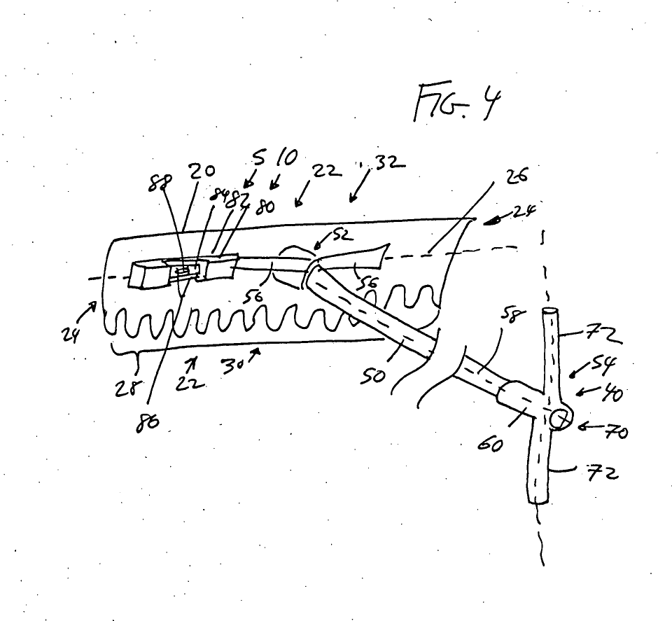

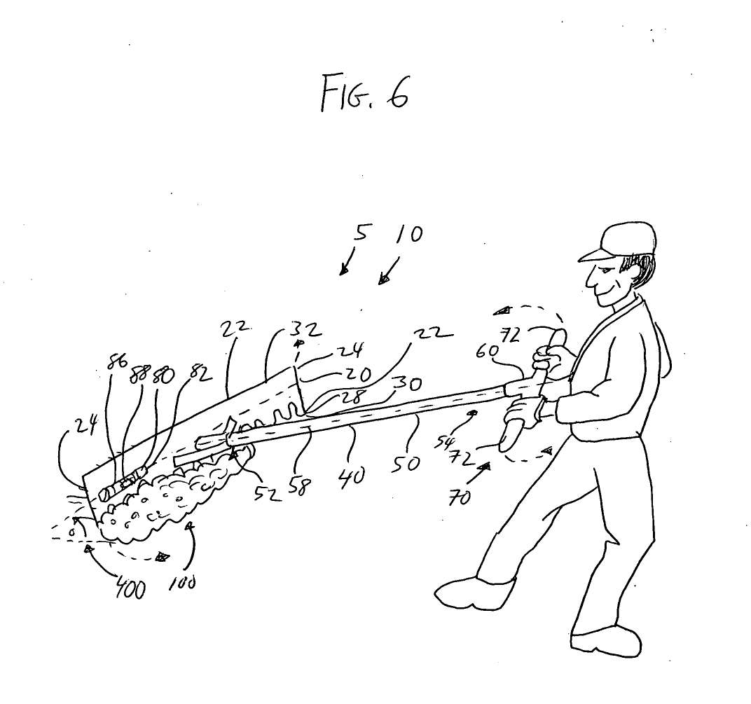

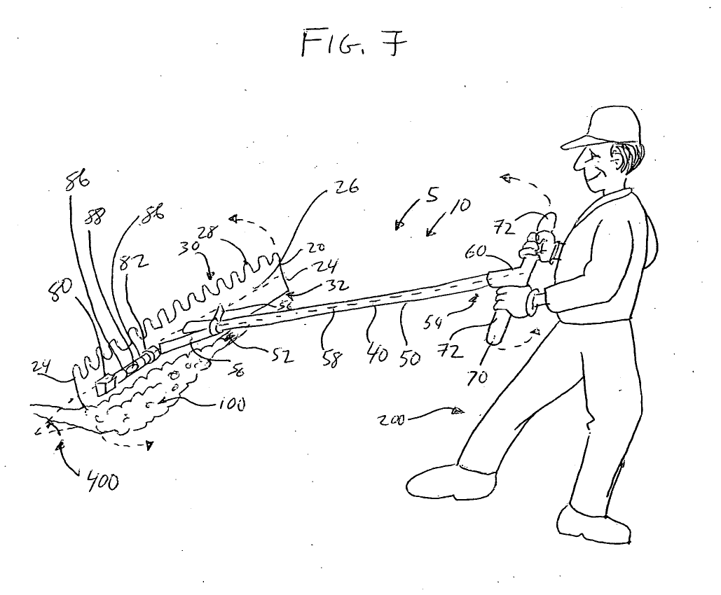

As shown in FIGS. 1-7, at least one possible embodiment of the invention could comprise a landscaping rake 5 comprising of body 10 that further incorporates a level measuring device or a grade and angle determination device 80 (e.g., a bubble level 82). The body 10 in at least one embodiment could comprise of blade 20 to which is attached a handle 40 for maneuvering the blade 20 in the material 100 being worked upon by the operator 200 of the rake 5. The handle 40 could have two ends 24 (a first or proximate end 52, and a second of distal end 54. The handle 40 could be generally attached by its proximate end 52 to the center 34 of the blade 20 in such a manner that the centerline axis 26 of the blade 20 is generally perpendicularly oriented to the longitudinal axis 58 of the handle 40

The blade 20 could comprise of two edges 22, two ends 24, and a centerline axis 26. In at least embodiment, one blade 20 could have an edge 22 with a plurality of tines 28 to form generally a tined edge 30 while the other edge 22 could substantially be a straight edge 32 to form generally a non-tined edge 32. The non-tined edge 32 with a straight edge 32 could be used to impart a finer grade to the material 100 such as particulate type matter (e.g., sand, decomposed gravel and the like.) The tined edge 30 could be used to generally impart a coarser grade and could be used on larger sized material 100 (such as gravel and the like.) The blade 20 could be made from aluminum or other suitable metal, polymers and the like.

The handle 40 could comprise of a handle body 50 and a torsional grip 60. As with most standard landscaping rakes, the handle body 50 could be an elongated tube or shaft. The first or proximate end 52 could be attached by appropriate means to the generally center portion of the blade 20. In at least one embodiment, the first end 52 could be attached to the midsection of the centerline axis 26 of the blade 20. In at least one embodiment, the handle body 50 could further feature a plurality of struts 56 which may used to further attach and stabilize the blade 20 to the first end 52.

A torsional grip 60 could be perpendicularly located at the distal end 54 of the handle 40. The torsional grip 60 could possibly provide sufficient structure and leverage for the operator 200 to grasp the rake 5, generally enabling the operator 200, if so desiring, to impart a sufficient amount of leverage to create a torsional force (e.g., a rotation force about the longitudinal axis 58 of the handle 40.) In this manner, the torsional force could be substantially imparted to the blade 20 causing one end 24 to generally further dig into the material 100 while the other respective end 24 could move further out from contact with the material 100.

In at least one embodiment, the torsional grip 60 could be formed along the lines of shovel-type handle 62. Such a shovel-type handle 62 could have a Y-shaped yoke 64 with the base of the yoke 64 generally attached to the second or distal end 54 of the handle body 50. The yoke 64 could have two ends 66, which may be generally connected to one another by a grip 68, a tube or a shaft that could be grasped by one or more hands of the operator 200. The grip 68 could be long enough to allow the operator 200 to grasp with it both hands simultaneously (e.g., one hand grasping palm up while the other hand grasping palm down.) The grip 68 could be oriented to be substantially perpendicular to the longitudinal axis 58 of the handle body 50.

In another embodiment of invention, the torsional grip 60 may be a T-shaped handle 70 with projecting gripping ends 72. The T-shaped handle 70 could be so structured that it's gripping ends 72 project outward from the handle body 50 to be substantially perpendicular to the longitudinal axis 58 of the handle body 50. Each gripping end 72 could generally be long enough to accommodate at least one hand of the user.

The torsional grip 60 can be oriented relative to the blade 20 to either be generally parallel or generally perpendicular to the centerline axis 26 of the blade 20. In this manner, the operator 200, while substantially grasping the handle 40 to push or pull the rake 5 to work the material 100 may, by pulling down on one gripping end 72 (or pulling up on the other gripping end 72 or doing both actions), substantially impart a torque (e.g., rotational or twisting force) to the handle 40 (and hence the blade 20). This torsion or rotational force upon the blade 20 could impart to the material 100 being worked upon by the operator 200 a grade having a desired angle of inclination 400. Further, the angle of inclination 400 of the actual grade of the material 100 could be checked by resting the edge 22 of the blade 20 upon the top surface of the material 100.

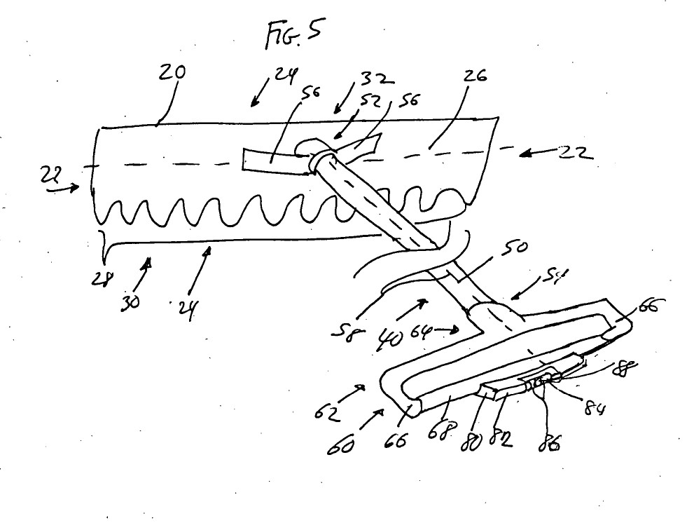

The grade and angle determination device 80 could be attached to the body 10 to allow the operator 200 to generally continuously gauge the angle of inclination of the grade (being imparted by the invention or the actual grade of the material) while operating the invention, 0. The grade and angle determination device 80 could be so positioned to allow the operator 200 to check regardless of the position of the rake 5, and if necessary change the angle of inclination of the rake 5 (e.g., blade 20) 9 (and thus the grade of the material) through the appropriate application of torque to the rake 5. The grade and angle determination device 80 could also be used to determine the angle of inclination 400 (shown in FIG. 5) for the current grade of the material 100.

One such grade and angle determination device 80 could be a standard bubble level 82. The bubble level 82 could be comprised of an enclosed clear tube 84 containing sufficient liquid to form a bubble 88. The tube 84 could have markings, such as gradient rings 86, to help the operator 200 note the position of the bubble 88 within the tube 84. In another version, not shown, the bubble level 82 could have a tube or vial 84 that is curved and have additional gradient rings 86 to measure angles of inclination 400 of steeper grades.

The bubble level 82 can be adapted from a Speedlite® leveling square from Swanson Tool Company, 211 Ontario Street, Frankfort, Ill. 60423. The bubble level 82 comes with an attached protractor which may be sawn off from the body of the bubble level 82. The bubble level 82 then may be attached to the body 10 through a variety of means including silicone adhesive, fasteners and the like.

The grade and angle determination device 80 could be placed so that the operator 200 can have a clear vision of the bubble level 82 while working the invention. One possible placement could be on the blade 20 along the centerline axis 26 on the side of the blade 20 facing the handle 40. In another possible embodiment. The grade and angle determination device 80 could be placed on the handle, such as being proximate to the torsional grip 60.

Another grade and angle determination device 80 could be an inclinometer (e.g., a clinometer) 90 that could comprise a half disc 92 sectioned off by angle markings to which is moveably affixed a weighted dial or indicator 94 that would be moved by the force of gravity to reflect the angle of inclination. The inclinometer 86 could be affixed to the body 10 in such a fashion so as to allow indicator 94 to move and show the angle of inclination 400 of the blade 20. Although not shown, other angle measuring devices, including electronic versions of the grade and angle determination device 80, could also be used as well.

Process

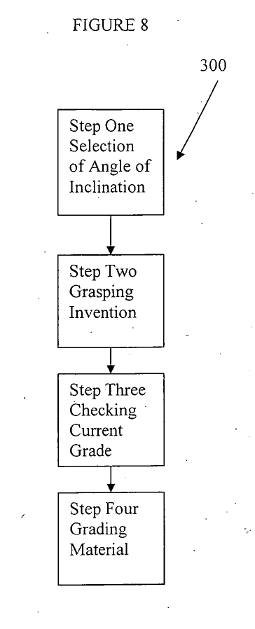

As substantially shown in FIG. 8, one embodiment could be a process or method 300 of operating the invention. Step one could be the selection of the angle of inclination for the grade that is to be applied to the material 100 being worked upon by the operator 200. After step one is substantially completed, the process 300 could move upon to step two, grasping the invention.

At step two grasping the invention, the operator could place one hand or more hands onto the torsional grip 60 to move and otherwise operate the rake 5. In one version of grasping, the operator 200 could grasp the torsional grip 60 with one hand palm down while the other hand grasps the torsional grip 60 palm up. At the substantial completion of step 2, the process 300 could move onto step 3, checking the current grade of the material 100.

At step three, checking the current grade of the material 100, the operator could move the rake 5 so that at least one edge 22 comes into contact and rests upon the material 100. The operator 200 could use the grade and angle determination device 80 to find out the angle of inclination for the current grade of the material 100. After substantially completing step three, the process 300 could proceed onto step four, grading or leveling the material.

In step four, grading or leveling the material, the operator 200 could decide on what angle of inclination 400 should be for the new grade being imparted to the material 200. After deciding on the new angle of inclination, the operator 200 could apply force to the torsional grip 60 to create a torque or rotating force to the handle 40 along its longitudinal axis 58. In this manner, as described above, the blade's angle of inclination 400 can be made to match the angle of inclination 400 for the desired grade. The operator 200 then through to the blade 20, could create a sufficient force to move the material 100 in such a fashion as to impart a grade having the desired angle of inclination 400. The operator 200, simultaneously, could monitor the grade and angle determination device 80 to ensure the angle of inclination 400 of the blade 20 is the desired one for the new grade. If the angle of inclination for the blade 20 needs to be changed for maintaining the desired grade, the operator through the torsional grip 60 could exert the appropriate torsional force to orient properly the blade 20 to the desired angle of inclination as indicated by the grade and angle determination device 80. The angle of inclination of the material 100 after grading could be checked, as stated above, by resting the blade 20 on top of the material 100 and checking the grade and angle determination device 80.

### CONCLUSION

As see through the above-description, the present invention provides for a means to measure the grade of material being work upon that also allow the user to measure and set forth the angle of incidence that can be used to set a new grade for the material being worked. Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A landscaping rake comprising:
(A) a body, the body comprising of a blade and a handle, the handle perpendicularly attaches to the center of the handle, and
(B) a grade and angle determination device, the grade determination device being attached to the body.

2. A landscaping rake of claim 1 wherein the grade and angle detection device attaches to the blade.

3. A landscaping rake of claim 1 wherein the grade and angle detection device attaches to the handle.

4. A landscaping rake of claim 1 wherein the grade and angle detection device attaches to the body in such a manner to allow clear viewing the grade detection device by the operator during operation of the rake.

5. A landscaping rake of claim 1 wherein the handle further comprises handle body and a torsional grip, the torsional grip attaches to the handle body in a perpendicular orientation.

6. A landscaping rake of claim 5 wherein a torque may be applied to the torsional grip, which transmits a torque through the handle body to the bade.

7. A landscaping rake of claim 6 wherein the torque is used to change the angle of inclination of the blade that is measured by the grade and angle detection device.

8. A landscaping rake of claim 1 wherein the grade and angle detection device is used to measure the grade of the material being worked upon by the operator of the landscaping rake.

9. A landscaping rake of claim 1 wherein grade and angle determination device is a bubble level.

10. A landscaping rake of claim 1 wherein the grade and angle determination device is an inclinometer.

11. A hand-operated landscaping rake comprising:
(A) a blade means for contacting particulate matter,
(B) a handle means for transmitting force to the blade means, and
(C) a grade and angle determination means for determining an angle of inclination of the blade means.

12. A hand-operated landscaping rake of claim 9 the handle means further comprising a gripping means, which is perpendicularly attached to the handle means, for transmitting a torque upon a handle means.

13. A hand-operated landscaping rake of claim 10 wherein the gripping means further transmitting a torque upon a blade means.

14. A hand-operated landscaping rake of claim 10 wherein the grade and angle detection means is located on the handle means.

15. A hand-operated landscaping rake of claim 10 wherein the grade and angle detection means is located on the blade means.

16. A method of operating a landscaping rake comprising:
(A) providing a rake with a body to which is attached a grade and angle determination device, the body further comprising of a blade with a handle attached to the blade,
(B) grasping the handle to move the rake,
(C) placing the blade in contact with matter being worked upon by the operator of the rake, and
(D) observing the grade and angle determination device to determine an angle of inclination of the grade of the matter being worked upon by the operator of the rake.

17. A method of claim 16 further comprises determining new angle of inclination for a new grade for the matter.

18. A method of claim 17 further comprises orienting the blade to the new angle of inclination as shown by the grade and angle determination device.

19. A method of claim 18 wherein orienting the blade may be accomplished by a torque applied to the blade, the torque resulting from applying force to a torsional grip which is perpendicularly attached to the handle body of the handle.

20. A method of claim 18 further comprising moving the blade through at least a portion of the material while maintaining the orientation of the blade relative to the new angle of inclination.
